(19) United States
(12) Patent Application Publication
(10) Pub. No.: US 2025/0030652 A1
(43) Pub. Date: Jan. 23, 2025

(54) MESSAGE DISPLAY METHOD AND APPARATUS, DEVICE, AND STORAGE MEDIUM

(71) Applicant: Beijing Zitiao Network Technology Co., Ltd., Beijing (CN)

(72) Inventors: Weiyi CHANG, Beijing (CN); Shuyu CHEN, Beijing (CN)

(21) Appl. No.: 18/713,586

(22) PCT Filed: Nov. 24, 2022
(86) PCT No.: PCT/CN2022/133929

§ 371 Date: May 24, 2024

(30) Foreign Application Priority Data
Nov. 26, 2021 (CN) 202111424228.X

(51) Int. Cl. H04L 51/04; H04L 51/10

(52) U.S. Cl. CPC H04L 51/04; H04L 51/10

(57) ABSTRACT

The present disclosure provides a message display method and apparatus, a device, and a storage medium. The message display method includes: displaying a content sharing interface during content sharing between at least two users, where the content sharing interface is used to present preset media content shared between the at least two users, and user identifiers of a first size of the at least two users are displayed in the content sharing interface; receiving a first message sent by a first user; and displaying the first message at a first position in a first region of the content sharing interface that is associated with a user identifier of the first user.

The present application claims priority to Chinese Patent Application No. 202111424228.X, filed with the China National Intellectual Property Administration on Nov. 26, 2021, which is incorporated herein by reference in its entirety.

### TECHNICAL FIELD

The present disclosure relates to the field of Internet technologies, and for example, to a message display method and apparatus, a device, and a storage medium.

### BACKGROUND ART

With rapid development of Internet technologies and terminal technologies, it is increasingly convenient for users to interact with each other. A plurality of users can even share the same piece of video stream content, and users who share a video can communicate with each other through voice. However, when it is inconvenient for users to perform voice communication, for example, when others may be disturbed, it is necessary to provide a better interaction mode and a better interactive presentation effect between users.

### SUMMARY OF THE INVENTION

The present disclosure provides a message display method and apparatus, a storage medium, and a device, which may implement message display during content sharing.

An embodiment of the present disclosure provides a message display method. The method includes:
displaying a content sharing interface during content sharing between at least two users, where the content sharing interface is used to present preset media content shared between the at least two users, and user identifiers of a first size of the at least two users are displayed in the content sharing interface;
receiving a first message sent by a first user; and
displaying the first message at a first position in the content sharing interface that is associated with a first user identifier, where the first user identifier is a user identifier corresponding to the first user, and the first position is included in a first region.

An embodiment of the present disclosure further provides a message display apparatus. The apparatus includes:
a content sharing interface display module configured to display a content sharing interface during content sharing between at least two users, where the content sharing interface is used to present preset media content shared between the at least two users, and user identifiers of a first size of the at least two users are displayed in the content sharing interface;
a message receiving module configured to receive a first message sent by a first user; and
a message display module configured to display the first message at a first position in the content sharing interface that is associated with a first user identifier, where the first user identifier is a user identifier corresponding to the first user, and the first position is included in a first region.

An embodiment of the present disclosure further provides an electronic device. The electronic device includes a memory, a processor, and a computer program stored on the memory and executable on the processor, where when the processor executes the computer program, the message display method provided in the embodiment of the present disclosure is implemented.

An embodiment of the present disclosure further provides a computer-readable storage medium storing a computer program, where when the computer program is executed by a processor, the message display method provided in the embodiment of the present disclosure is implemented.

### BRIEF DESCRIPTION OF DRAWINGS

FIG. 1 is a diagram of a scenario architecture of an application scenario to which a message display method according to an embodiment of the present disclosure is applicable;

FIG. 2 is a schematic flowchart of a message display method according to an embodiment of the present disclosure;

FIG. 3 is a schematic flowchart of another message display method according to an embodiment of the present disclosure;

FIG. 4 is a schematic diagram of interface interaction in a message display method according to an embodiment of the present disclosure;

FIG. 5 is a schematic flowchart of still another message display method according to an embodiment of the present disclosure;

FIG. 6 is a schematic diagram of interface interaction in another message display method according to an embodiment of the present disclosure;

FIG. 7 is a block diagram of a structure of a message display apparatus according to an embodiment of the present disclosure; and

FIG. 8 is a block diagram of a structure of an electronic device according to an embodiment of the present disclosure.

### DETAILED DESCRIPTION OF THE INVENTION

The embodiments of the present disclosure are described below with reference to the accompanying drawings. Although some embodiments of the present disclosure are shown in the accompanying drawings, the present disclosure may be implemented in various forms and should not be construed as being limited to the embodiments set forth herein. Rather, these embodiments are provided for understanding the present disclosure. The accompanying drawings and the embodiments of the present disclosure are only for exemplary purposes, and are not intended to limit the scope of protection of the present disclosure.

The plurality of steps described in method implementations of the present disclosure may be performed in different orders, and/or performed in parallel. Furthermore, additional steps may be included and/or execution of the illustrated steps may be omitted in the method implementations. The scope of the present disclosure is not limited in this respect.

The term “include/comprise” used herein and variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

Concepts such as “first” and “second” mentioned in the present disclosure are only used to distinguish between different apparatuses, modules, or units, and are not used to limit the sequence or interdependence of functions performed by these apparatuses, modules, or units.

The modifiers “a/an” and “a plurality of” mentioned in the present disclosure are illustrative and not restrictive, and unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Each of the following plurality of embodiments provides both optional features and examples. A plurality of features described in the embodiment may be combined into a plurality of optional solutions, and each numbered embodiment should not be considered as only one technical solution.

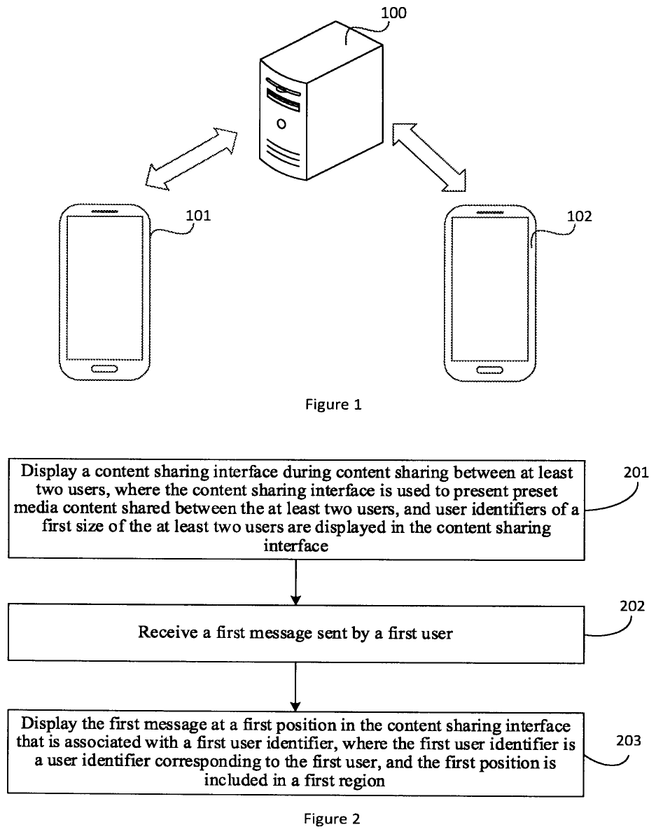

FIG. 1 is a diagram of a scenario architecture of an application scenario to which a message display method according to an embodiment of the present disclosure is applicable. Referring to FIG. 1, the application scenario may include a server 100, a first electronic device 101, and a second electronic device 102. There may be more electronic devices, which is not limited. FIG. 1 is merely for the purpose of schematic illustration. A plurality of electronic devices establish a communication connection to the server for information exchange. The electronic device may be a mobile device such as a mobile phone, a smart watch, a tablet computer, or a personal digital assistant; or may be other devices such as a desktop computer. Users who use the electronic devices may perform a real-time call, content sharing, message exchange, etc. with each other through a preset network platform installed on the electronic devices. In this embodiment of the present disclosure, content sharing during a call may be referred to as call sharing. The preset network platform may be a preset website or a preset application. The server may provide support for the preset network platform.

FIG. 2 is a schematic flowchart of a message display method according to an embodiment of the present disclosure. The method may be performed by a message display apparatus. The apparatus may be implemented by software and/or hardware and may be integrated into an electronic device. The electronic device may be, for example, an electronic device used by any of users who participate in content sharing. As shown in FIG. 2, the method includes the following steps.

Step 201: Display a content sharing interface during content sharing between at least two users, where the content sharing interface is used to present preset media content shared between the at least two users, and user identifiers of a first size of the at least two users are displayed in the content sharing interface.

In this embodiment of the present disclosure, a real-time call between two or more users may be supported, which may be a voice call, a video call, etc. In order to meet a requirement for content sharing between the users, the content sharing interface may be displayed during a call. During the display of the content sharing interface, the real-time call between the users may be held; that is, the users who participate in the call may continue the call while viewing the content sharing interface.

For example, the content sharing interface is used to present the preset media content shared between the users who participate in the call. The form of the preset media content is not limited, which may, for example, be a video, an image, a document, or another form of content. The preset media content may be set by any user who participates in the call or by a specified user, which is not limited.

For example, a display time of the content sharing interface, a display trigger condition, etc. may be set according to actual situations. For example, after a call event is triggered, a call interface is entered, in which a share control is displayed. When the user triggers the share control, a redirection to the content sharing interface is made, and the user selects the preset media content for sharing. For another example, after a call event is triggered, a call interface is entered, in which a shared content select control is displayed. After the user triggers the shared content select control and selects the preset media content, a redirection to the content sharing interface is made, and the preset media content is displayed. For still another example, a content identifier corresponding to the preset media content is displayed on a preset page. After a call sharing event corresponding to the content identifier is triggered, a call is initiated, and the content sharing interface is entered to display the preset media content.

In this embodiment of the present disclosure, for different users who participate in the call, the call interface and/or the content sharing interface may be synchronously displayed, or the users may independently determine a display time in local devices or switch the display between the two interfaces.

For example, after the content sharing interface is entered and displayed, user identifiers of the first size of the users who participate in the call are displayed in the content sharing interface. The first size may be understood as a current display size of the user identifier, the value of which is not limited. Content of the user identifier is not limited, and may include, for example, a user name, a user avatar, or a real-time video image of the user. Optionally, the user identifiers of the first size of the at least two users are displayed in a preset region of the content sharing interface. The preset region may be understood as a region in the content sharing interface that is used for displaying the user identifiers together. The shape, size, position, etc. of the region are not limited. The preset region may be fixedly preset, or may dynamically change according to actual situations. Optionally, to avoid excessively covering the preset media content, the preset region may be located at or near a boundary of the content sharing interface, such as at the top of the interface, at the bottom of the interface, at the left boundary of the interface, or at the right boundary of the interface. Optionally, the user identifiers are resident in the preset region. Alternatively, the user identifiers are resident in the preset region when no message is displayed, and some user identifiers are resident in the preset region when a message is displayed; that is, some user identifiers may be hidden when the message is displayed.

Step 202: Receive a first message sent by a first user.

For example, the plurality of users who participate in the call may communicate with each other through voice while viewing the content sharing interface. However, voice communication is not suitable in some cases, for example, when voice communication may disturb others around, the surrounding is noisy, or it is hard to accurately convey information that the user wants to deliver (such as an excited look) through voice. In this case, the user usually mutes the call, and a message including visual information such as text or an emoji may be more in line with a requirement of the user. Therefore, in this embodiment of the present disclosure, richer modes of receiving and displaying a visual message are provided during call sharing, and different messages are presented based on characteristics and attributes of visual interaction, to improve the user experience.

For example, the first user may be any one of the users who participate in the call. The first message may be any message sent by the user, and the message form and message content are not limited. For example, the first message may be a message including a character string, a message including an emoji, or a message including both a character string and an emoji.

For example, when the first user is a user of a local device, receiving the first message sent by the first user may be understood as receiving the first message input by the first user through a message input box of the local device; or when the first user is a user of a peer device, receiving the first message sent by the first user may be understood as receiving the first message sent by the first user through the peer device and forwarded by a server.

Step 203: Display the first message at a first position in the content sharing interface that is associated with a first user identifier, where the first user identifier is a user identifier corresponding to the first user, and the first position is included in a first region.

For example, the first region may be understood as a region in the content sharing interface that is used for displaying a message or displaying a message of a specified type (where the specified type includes a message type of the first message), and the shape, size, etc. of the region are not limited. The first region may include one connected region, or may include a plurality of separate subregions. A relative position relationship between the preset region and the first region may be preset, for example, to be adjacent to, to overlap with, or to be at a distance (which may be a distance between central points of the regions) within a preset distance range. The first region may be fixedly preset, or may dynamically change according to actual situations.

For example, when the first message needs to be displayed, a display position of the user identifier of the first user who sends the first message, that is, a first display position at which the first user identifier is currently displayed in the preset region (when a position of the first user identifier changes due to the need to display the first message, the first display position is usually a changed display position), may be determined. To help a call participant know a sender of the first message, the first message is displayed at the first position associated with the first display position. The association may be understood as the first position being in the vicinity of the first user identifier, which may mean that a minimum distance between the first display position and the first position is less than a preset distance value. In this way, because the user identifier is resident, a visual feeling of the first user saying the first message can be created, such that the user feels as if the first user is taking right next to him/her, enhancing a sense of companionship.

For example, a display form of the first message is not limited. For example, the first message may be displayed in the form of a bubble, and the shape of the bubble is not limited. A start point of the bubble may point to the first user identifier.

According to the message display method provided in this embodiment of the present disclosure, the content sharing interface is displayed during the content sharing between the at least two users, where the content sharing interface is used to present the preset media content shared between the at least two users, and the user identifiers of the first size of the at least two users are displayed in the content sharing interface; the first message sent by the first user is received; and the first message is displayed at the first position in the first region of the content sharing interface that is associated with the user identifier of the first user. With the above technical solution, a plurality of users who are sharing content may interact with each other by sending messages during the process of viewing shared content, such that the forms of interaction between the users in a sharing scenario when voice interaction is not suitable are enriched, and the convenience for interaction is ensured. In addition, a display position of a message is associated with a user identifier of a user who sends the message, which can enhance a sense of companionship between the users, facilitate enlivening an interactive atmosphere and improve an interaction effect.

In some embodiments, the displaying the first message at a first position in the content sharing interface that is associated with a first user identifier includes: displaying the first message at the first position in the content sharing interface that is associated with the first user identifier, when a first preset display condition is satisfied. With such a setting, a specific display condition is set for the display of the message, to improve the user experience.

In some embodiments, the first preset display condition being satisfied includes the following: a number of messages currently displayed in the first region does not reach a first preset number threshold. With such a setting, an upper limit of a number of messages simultaneously displayed in the first region can be controlled to avoid excessively covering the preset media content by excessive messages. The first preset number threshold may be set according to actual situations. For example, the first preset number may be determined with reference to a total number of user identifiers currently displayed in the preset region (for example, ½ of the total number is rounded), or may be determined with reference to a display state of the user identifier.

In some embodiments, after the displaying the first message at a first position in the content sharing interface that is associated with a first user identifier, the method further includes: stopping the display of the first message after a display duration of the first message reaches a first preset duration. With such a setting, an earlier message may be cleared from the content sharing interface in a timely manner, to reduce the time for covering interface content. The first preset duration may be set, for example, to 3 seconds according to actual situations.

In some embodiments, the method further includes: when the first message is displayed and the first message is a message that is displayed earliest among messages currently displayed in the first region, and a second message that is sent by a second user and that is to be displayed in the first region is received, determining, if a number of messages currently displayed in the first region has reached a first preset number threshold, whether a display duration of the first message reaches a second preset duration, where the second preset duration is less than a first preset duration; and stopping the display of the first message if the display duration of the first message has reached the second preset duration, and displaying the second message at a second position in the first region that is associated with a second user identifier, where the second user identifier is a user identifier corresponding to the second user. With such a setting, when there is a new message to be displayed, a display duration of an earlier message may be shortened such that the new message can be displayed faster, thereby ensuring the display efficiency of the message and improving the timeliness of message exchange. The value of the first preset number threshold preset in this embodiment may be the same as that of the first preset number threshold mentioned in the previous embodiment, or may be a new different value, which is not limited herein.

The second user may be any one of the users who participate in the call, and may be the first user or a user other than the first user. It is assumed that the first preset duration is 3 seconds and the second preset duration is 2 seconds. Before the display duration of the first message reaches 3 seconds, the first message remains displayed. Before the second message is received, another message may be received and displayed. When the second message is received, if the number of messages displayed in the first region has reached the first preset number threshold, it indicates that the second message cannot be displayed at the moment. In this case, if the first message is the earliest message among the currently displayed messages, whether the display duration of the first message is greater than or equal to 2 seconds is determined. If the display duration of the first message is greater than or equal to 2 seconds, the first message is cleared, and the second message is displayed. If the display duration of the first message is still less than 2 seconds, the process may wait until the display duration reaches 2 seconds, and then the first message is cleared and the second message is displayed. Therefore, the second message can be displayed faster, without the need to wait until the first message has been displayed for 3 seconds. The second user identifier may be associated with the second location in a manner similar to the manner in which the first user identifier is associated with the first location. Details are not described herein again.

In some embodiments, the method further includes: when the first message is displayed and the first message is a message that is displayed earliest among messages currently displayed in the first region, and a second message that is sent by a second user and that is to be displayed in the first region is received, stopping the display of the first message if a number of messages currently displayed in the first region has reached a first preset number threshold, and displaying the second message at a second position in the first region that is associated with a second user identifier, where the second user identifier is a user identifier corresponding to the second user. With such a setting, a new message can be displayed as soon as possible, reducing a delay in message display, improving the timeliness of message exchange, and providing a more real chat scene. The value of the first preset number threshold preset in this embodiment may be the same as that of the first preset number threshold mentioned in the previous embodiment, or may be a new different value, which is not limited herein.

In some embodiments, a display state of the user identifier further includes a user identifier of a second size, and the second size is less than the first size. The method further includes: performing switching between the display of the user identifier of the first size and the display of the user identifier of the second size when a preset switching operation is received. With such a setting, the display state of the user identifier can be controlled more flexibly. When the user identifier of the first size has a different shape from the user identifier of the second size, a display size may be measured by area. The preset switching operation may be Drag, Double-click, Tap, etc. An object upon which the preset switching operation acts may be any user identifier or a specified user identifier. Switching from the user identifier of the first size to the user identifier of the second size may correspond to a first preset switching operation. Switching from the user identifier of the second size to the user identifier of the first size may correspond to a second preset switching operation. The first preset switching operation may be the same as or different from the second preset switching operation. For example, the first preset switching operation is Drag, and the second preset switching operation is Tap.

Content in the user identifier of the first size may be the same as or different from that in the user identifier of the second size. Optionally, the user identifier of the first size and the user identifier of the second size each include an avatar of a corresponding user. Alternatively, the user identifier of the first size includes a real-time video image of a corresponding user, and the user identifier of the second size includes an avatar of a corresponding user. By presenting a real-time video image in a large-sized user identifier, a sense of companionship between the users can be enhanced, and the user experience can be improved. In addition, the use of a small-sized user identifier is more in line with a requirement of a user to enhance the viewing experience of shared content and a requirement of the user for less covering the shared content.

In some embodiments, the displaying the first message at a first position in the content sharing interface that is associated with a first user identifier includes: displaying the first message at the first position in the content sharing interface that is associated with the first user identifier, when a first preset display condition is satisfied. The first preset display condition is determined based on the display state of the user identifier. The display state of the user identifier may include a display state of the first size and a display state of the second size. With such a setting, the display of the message can be controlled more flexibly. The first preset display condition preset in this embodiment may be the same as or different from the first preset display condition mentioned in the previous embodiment, which is not limited herein.

In some embodiments, the first preset display condition being satisfied includes the following: switching between the display of the user identifier of the first size and the display of the user identifier of the second size is not currently performed. With such a setting, the user is prevented from missing content of a new message due to the message being covered by hand when the user inputs the preset switching operation. In addition, the complexity of display logic can also be reduced, and device resources can be saved.

In some embodiments, the first preset display condition being satisfied includes the following: a number of messages currently displayed in the first region does not reach a first preset number threshold, where the first preset number threshold is determined based on the display state of the user identifier, and a first preset number threshold in a display state of the user identifier of the first size is greater than a first preset number in a display state of the user identifier of the second size. The value of the first preset number threshold preset in this embodiment may be the same as that of the first preset number threshold mentioned in the previous embodiment, or may be a new different value, which is not limited herein. With such a setting, less covering the preset media content is implemented in a display state of a small-sized user identifier. If the user switches to the small-sized user identifier, it indicates that the user may expect to view the preset media content more completely. In this case, an upper limit of the number of messages simultaneously displayed may be set to a lower level, to meet a user requirement. For example, a maximum of two messages are displayed in the first region in the display state of the user identifier of the first size; and a maximum of one message is displayed in the first region in the display state of the user identifier of the second size.

In some embodiments, a presentation mode of a currently displayed message is determined based on the display state of the user identifier. With such a setting, the presentation mode of the message can be controlled more flexibly.

In some embodiments, a presentation mode of a currently displayed message includes at least one of a size of the first region, a position of the first region, a relative position between the first region and the user identifier, a presentation style of message content, and a layout of the message content. The presentation style of the message content may include, for example, a font, a font size, or a color. For example, in a display state of a large-sized user identifier, the user has a lower degree of rejection for covering a shared content picture and a higher requirement for a sense of companionship than in a display state of a small-sized user identifier. Therefore, it is possible to set, for example, a larger size of the first region, a position of the first region further away from the boundary of the interface, a longer distance between the first region and the user identifier, and a bigger font, a larger font size, and a looser layout for the message content.

In some embodiments, the size of the first region is determined based on the display state of the user identifier, and a size of the first region in the display state of the user identifier of the first size is greater than a size of the first region in the display state of the user identifier of the second size. With such a setting, if the user switches to a small user identifier, it indicates that the user may expect to view the preset media content more completely. In this case, the size of the first region may be set to be small, to meet a user requirement.

In some embodiments, before the first message is displayed, if it is determined that it is currently a display state of the user identifier of the second size, the display of a user identifier corresponding to a user, other than the first user, in the at least two users is stopped when the first message is displayed. With such a setting, only the user identifier of the first user who currently sends a message and the first message that is sent may be displayed in the first region, and another user identifier is hidden, which can reduce covering of the preset media content, conform to an original intention of the user to set the small-sized user identifier, and meet the user requirement.

In some embodiments, the method further includes: receiving a preset trigger operation that acts on a third message displayed in the first region, and displaying a message input box. With such a setting, the convenience for inputting a message can be improved. The third message may be sent by any user, which is not limited. A current user may input the preset trigger operation on the third message sent by the current user himself/herself, to display the message input box. Alternatively, the current user may input the preset trigger operation on the third message sent by another user, to display the message input box.

In some embodiments, the third message is sent by a third user. While the message input box is displayed, the method further includes: displaying associated information of the third user in the message input box. Such a setting can reduce operations performed by the user to input the associated information of the third user, and thus improve the efficiency of information exchange. The associated information may include, for example, a name of the third user, and may further include an associated symbol, etc. Optionally, in the message input box, the third user is set as a specified receiving user of a message to be sent, and a preset specified symbol such as “@” and the name of the third user are displayed. With such a setting, a message receiving object can be conveniently specified, and the efficiency of message exchange can be improved. In the above case, the third user is different from the current user who inputs the preset trigger operation.

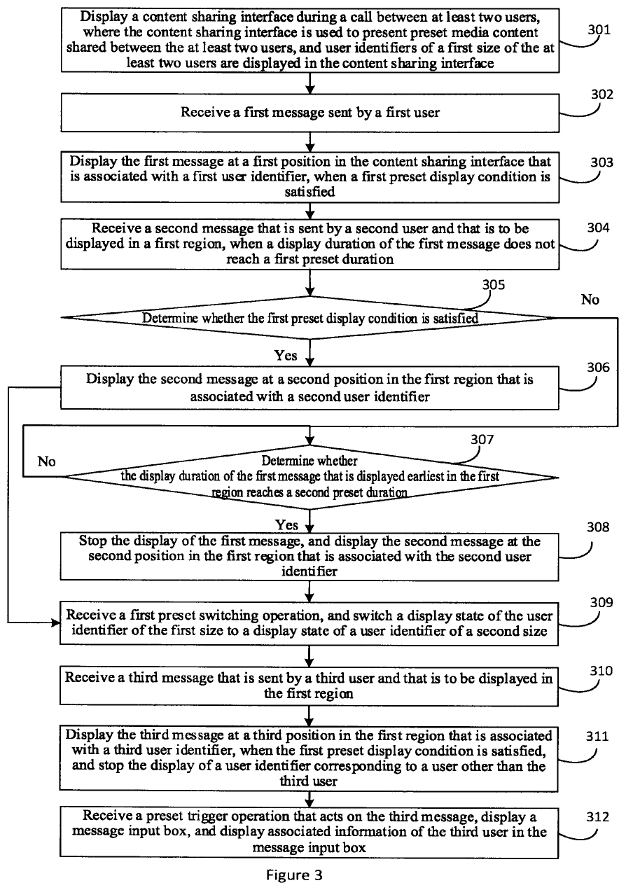

FIG. 3 is a schematic flowchart of another message display method according to an embodiment of the present disclosure. This embodiment of the present disclosure is described based on a plurality of optional solutions in the above embodiment. The method includes the following steps.

Step 301: Display a content sharing interface during a call between at least two users, where the content sharing interface is used to present preset media content shared between the at least two users, and user identifiers of a first size of the at least two users are displayed in the content sharing interface.

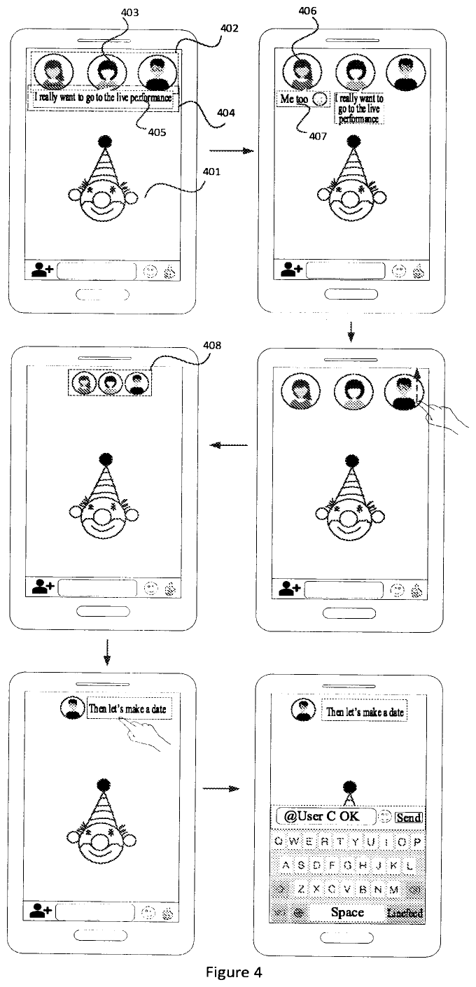

FIG. 4 is a schematic diagram of interface interaction in a message display method according to an embodiment of the present disclosure. As shown in FIG. 4, a clown video 401 is played in a content sharing interface. The clown video may be considered as preset media content shared between users who participate in a call. A preset region 402 is provided at the top of the content sharing interface. If there are three users who currently participate in the call, user identifiers of the three users are displayed in the preset region 402, which respectively correspond to a user A, a user B, and a user C from left to right. The user identifiers that are currently displayed are user identifiers of the first size, and real-time video images of a plurality of users may be displayed. If the user B is denoted as the first user, a first user identifier 403 is displayed.

Step 302: Receive a first message sent by a first user.

For example, if a device in FIG. 4 is a device used by the user A, and the user B sends a message “I really want to go to the live performance”, the message may be forwarded to the device of the user A through a server.

Step 303: Display the first message at a first position in the content sharing interface that is associated with the first user identifier, when a first preset display condition is satisfied.

The first preset display condition being satisfied includes the following: a number of messages currently displayed in a first region does not reach a first preset number threshold, and switching between the display of the user identifier of the first size and the display of a user identifier of a second size is not currently performed.

For example, the first preset number threshold is 2 in the display state of the user identifier of the first size. As shown in FIG. 4, a first region 404 is located below the preset region 402. There may be an intersection between the first region 404 and the preset region 402. Before the first message is displayed, if no message is currently displayed in the first region 404 and switching is not performed between large and small user identifiers, the first message may be displayed at the first position associated with the first user identifier 403. For example, in FIG. 4, content of the first message is displayed in the form of a first message bubble 405. A start point of the first message bubble 405 points to the first user identifier 403.

Step 304: Receive a second message that is sent by a second user and that is to be displayed in the first region, when a display duration of the first message does not reach a first preset duration.

For example, the first preset duration is 3 seconds. Within 3 seconds after the first message starts to be displayed, if the user A sends the second message, which includes text “Me too” and a smiling emoji, a display time of the second message needs to be determined according to a current situation.

Step 305: Determine whether the first preset display condition is satisfied. If the first preset display condition is satisfied, step 306 is performed. If the first preset display condition is not satisfied, step 307 is performed.

For example, if only the first message is currently displayed, the first preset number threshold is not reached, and when switching between the display of the large user identifier and the display of the small user identifier is not performed, step 306 may be performed; that is, the second message is displayed. If another message is currently displayed in addition to the first message, the first preset number threshold of 2 has been reached. In this case, step 307 needs to be performed.

Step 306: Display the second message at a second position in the first region that is associated with a second user identifier. Step 309 is performed.

For example, as shown in FIG. 4, the second message may be displayed at the second position associated with the second user identifier 406. Content of the second message may be displayed in the form of a second message bubble 407.

Step 307: Determine whether the display duration of the first message that is displayed earliest in the first region reaches a second preset duration. If the display duration of the first message that is displayed earliest in the first region reaches the second preset duration, step 308 is performed. If the display duration of the first message that is displayed earliest in the first region does not reach the second preset duration, step 307 is repeated.

For example, the second preset duration is less than the first preset duration, and may be 2 seconds. If the first message and another message have been displayed in the first region, and the display duration of the first message is longer, whether the display duration of the first message is greater than or equal to 2 seconds is determined. If the display duration of the first message is greater than or equal to 2 seconds, step 308 may be performed. If the display duration of the first message is not greater than or equal to 2 seconds, the process may continue to wait until the display duration of the first message reaches 2 seconds.

Step 308: Stop the display of the first message, and display the second message at the second position in the first region that is associated with the second user identifier.

For example, when the first message has been displayed for 2 seconds or more, the first message may be hidden. When it is determined that switching between the display of the user identifier of the first size and the display of the user identifier of the second size is not currently performed, the second message is displayed.

Step 309: Receive the first preset switching operation, and switch the display state of the user identifier of the first size to the display state of the user identifier of the second size.

For example, if a display duration of either of the messages in the first region has reached 3 seconds, the display of the messages may be stopped.

For example, as shown in FIG. 4, when the user A inputs a drag-up operation on the user identifier of the first size, it may be considered that the first preset switching operation is received. In this case, the display state of the user identifier of the first size is switched to the display state of the user identifier of the second size, and the avatar of the corresponding user may be displayed in the user identifier of the second size. After switching to the display state of the user identifier of the second size, the size of the preset region also decreases, resulting in, for example, a reduced preset region 408 displayed in FIG. 4. Optionally, the size of the first region also decreases. For example, the first region may overlap with the preset region, or have a larger overlapping area with the preset region.

Optionally, a preset interface switching operation (for example, Tap) may further be input for the user identifier of the first size, to implement switching from the content sharing interface to the call interface. After the local device is switched to the call interface, the peer device may be synchronously switched to the call interface or remain in the content sharing interface. After switching to the call interface, a playback progress of a shared video may dynamically change according to a playback strategy before switching. If there is a sound in the shared video, playback of the sound may be blocked. During the process of switching to the call interface, a back control may be displayed. The back control is triggered to go back to the content sharing interface.

Step 310: Receive a third message that is sent by a third user and that is to be displayed in the first region.

For example, the third message that is sent by the user C is received in the display state of the user identifier of the second size. It is assumed that message content is “Then let's make a date”.

Step 311: Display the third message at a third position in the first region that is associated with a third user identifier, when the first preset display condition is satisfied, and stop the display of a user identifier corresponding to a user other than the third user.

For example, the first preset number threshold is 1 in the display state of the user identifier of the second size. If no message is displayed in the first region when the third message is received, the third message may be displayed in the first region. When the third message is displayed, to reduce covering of the preset media content, the user identifiers of the first user and the second user may be hidden, and a display position of the user identifier of the third user may also change. As shown in FIG. 4, the third user identifier corresponding to the third user has changed from being displayed on the rightmost side to being displayed on the leftmost side, and the third message “Then let's make a date” is displayed on the right side of the third user identifier.

Step 312: Receive a preset trigger operation that acts on the third message, display a message input box, and display associated information of the third user in the message input box.

For example, if the user A wants to reply to the user C, the preset trigger operation, such as Tap, may be input for the third message. In this case, the message input box may be popped up in the content sharing interface, and the third user may be set as a specified receiving user of a message to be sent by means of automatically displaying a preset specified identifier (for example, “@”) in the message input box and displaying a nickname of the third user after the preset specified identifier, and the like.

According to the message display method provided in this embodiment of the present disclosure, a plurality of users who are making a call may interact with each other by sending messages during the process of viewing shared content, and display positions of the messages are associated with user identifiers of the users who send the messages, such that a sense of companionship between the users can be enhanced, the user identifier may be flexibly switched between a large user identifier and a small user identifier, and a display mode of the message may also change with a display state of the user identifier. In addition, the timeliness of the message and the prevention of excessively covering the shared content may be considered for the display time, the display position, etc. of the message, such that the user experience during call sharing is effectively improved.

In some embodiments, a message displayed in the first region is a text message, where the text message includes a character string. Optionally, the text message may include only the character string, or may include the character string and also other content, for example, an emoji.

In some embodiments, the method further includes: receiving a fourth message sent by a fourth user; and displaying the fourth message in a second region of the content sharing interface, where the fourth message is a picture message, the picture message includes a preset picture resource, and the second region is different from the first region. The picture message may include only the preset picture resource. Optionally, the picture message may be an emoticon message, and in this case, the preset picture resource may be, for example, an emoji. With such a setting, the text message and the picture message may be separately displayed in different regions, to provide a more suitable visual effect for presentation of the picture message, thereby enriching the display forms of messages. Optionally, a ratio of an area of the second region to an area of the content sharing interface is greater than a preset ratio threshold, such that the preset picture resource may be displayed within a relatively large range, making a display position of the preset picture resource more flexible.

Optionally, an input region of the emoticon message displayed in the second region may be the same as that of the text message. For example, both the emoticon message and the text message may be input from an input box. When an application determines that an input in the input box is an emoticon, the emoticon is displayed in the second region. When the application determines that an input in the input box is text, the text is displayed in the first region.

Alternatively, an input region of the emoticon message displayed in the second region may be different from that of the text message. For example, the text message is input from an input box, and the emoticon message is input from a preset emoticon input region. In the preset emoticon input region, an emoticon select control may be displayed, such that the user may quickly select an emoji and send a corresponding emoticon message by triggering the emoticon select control. When the emoticon message is received, a display region for the emoticon message is determined depending on a current input region. For example, if the current input region is a first input region, the emoticon message is displayed in the first region. If the current input region is a second input region, the emoticon message is displayed in the second region. Optionally, like the input region of the text message, the first input region is, for example, the input box. Unlike the input region of the text message, the second input region is, for example, the preset emoticon input region.

Optionally, the displaying the fourth message in the second region of the content sharing interface includes: displaying the fourth message at a fourth position in the second region of the content sharing interface. The fourth position is randomly determined. With such a setting, the display position of the preset picture resource is randomly determined, which can enhance the visual effect and interestingness of message exchange and enliven an atmosphere of call sharing.

In some embodiments, the displaying the fourth message in a second region of the content sharing interface includes: associatively presenting the preset picture resource in the fourth message and an avatar of the fourth user in the second region of the content sharing interface. With such a setting, a user who sends an emoticon can be intuitively presented, and the interestingness can be enhanced.

In some embodiments, the displaying the fourth message in a second region of the content sharing interface includes: displaying the fourth message in the second region of the content sharing interface when a second preset display condition is satisfied. The first preset display condition being satisfied includes the following: a number of messages currently displayed in the second region does not reach a second preset number threshold, and/or a frequency at which the fourth user sends the picture message does not reach a preset frequency threshold. With such a setting, a number of emojis that are displayed or a frequency at which a same user sends emojis is controlled to avoid excessively covering the shared content.

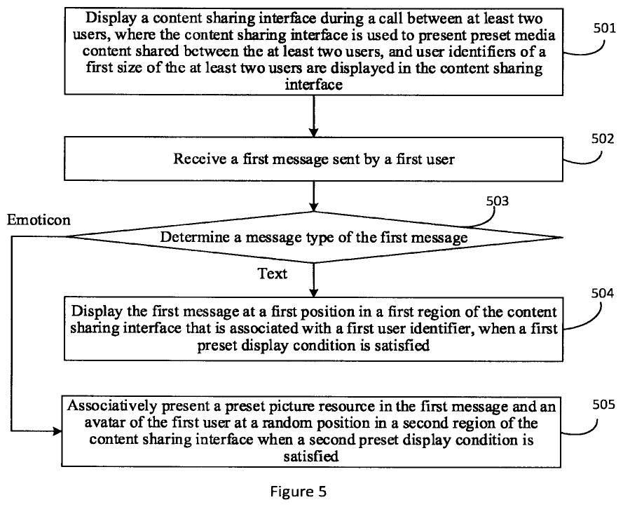

FIG. 5 is a schematic flowchart of still another message display method according to an embodiment of the present disclosure. This embodiment of the present disclosure is described based on a plurality of optional solutions in the above embodiment. The method includes the following steps.

Step 501: Display a content sharing interface during a call between at least two users, where the content sharing interface is used to present preset media content shared between the at least two users, and user identifiers of a first size of the at least two users are displayed in the content sharing interface.

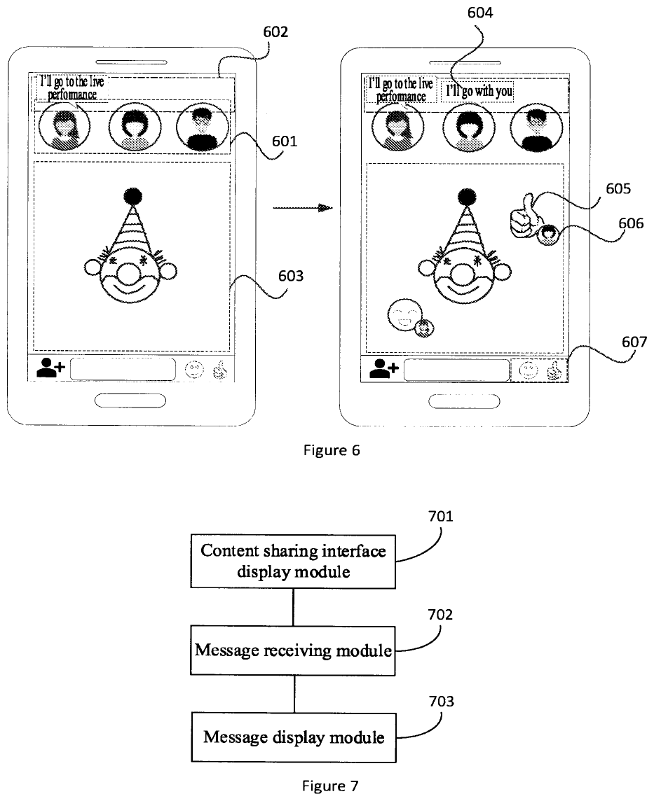

FIG. 6 is a schematic diagram of interface interaction in another message display method according to an embodiment of the present disclosure. As shown in FIG. 6, a clown video is played in a content sharing interface. The content sharing interface has a preset region 601, a first region 602, and a second region 603. If there are three users who currently participate in the call, user identifiers of the first size of the three users are displayed in the preset region 601, which respectively correspond to a user A, a user B, and a user C from left to right.

Step 502: Receive a first message sent by a first user.

For example, as shown in FIG. 6, it is assumed that the first user is the user B, and the user B sends the first message “I'll go with you”.

Step 503: Determine a message type of the first message. If the message type is a text type, step 504 is performed. If the message type is an emoticon type, step 505 is performed.

For example, the above example “I'll go with you” may be determined as a text message, and then step 504 may be performed.

Step 504: Display the first message at a first position in the first region of the content sharing interface that is associated with a first user identifier, when a first preset display condition is satisfied.

For example, the first preset display condition being satisfied includes the following: a number of messages currently displayed in the first region does not reach a first preset number threshold, and switching between the display of the user identifier of the first size and the display of a user identifier of a second size is not currently performed. It is assumed that the first preset number threshold is 2. As shown in FIG. 6, the number of messages that are currently displayed is 1 (a message “I'll go to the live performance” that is sent by the user A has been displayed), which is less than 2. Therefore, when switching between large and small user identifiers is not performed, “I'll go with you” 604 may be displayed, in the form of a text bubble, at a position in the first region 602 that is associated with the user identifier of the user B.

Step 505: Associatively present a preset picture resource in the first message and an avatar of the first user at a random position in the second region of the content sharing interface when a second preset display condition is satisfied.

For example, the first preset display condition being satisfied includes the following: a number of messages currently displayed in the second region does not reach a second preset number threshold, and a frequency at which a fourth user sends an emoticon message does not reach a preset frequency threshold. It is assumed that the first preset number threshold is 5. As shown in FIG. 6, if the user B sends a message including a thumb emoticon, it may be determined that the message is an emoticon message. In this case, the message may be displayed in the second region 603 when the second preset display condition is satisfied. A thumb emoji 605 and an avatar 606 of the user B may be associatively displayed at a random position in the second region 603. As shown in FIG. 6, if the user A sends an emoticon message including a smiling face later, the emoticon message may continue to be randomly displayed in the second region.

Optionally, when it is determined that the message type of the first message is an emoticon message, a determination may also be made. For example, a determination as to whether an input region of the first message is the same as an input region of a text message is made. If the input region of the first message is the same as the input region of the text message, the emoticon message is displayed in the first region 602. If the input region of the first message is not the same as the input region of the text message, the emoticon message is displayed in the second region 603. If an input region of the emoticon message is an input box, the emoticon message is displayed in the first region 602. If an input region of the emoticon message is a preset emoticon input region 607, the emoticon message is displayed in the second region 603. Optionally, one or more emoticon select controls, such as a smiling face control and a thumb control that are shown in FIG. 6, may be presented in the preset emoticon input region 607, such that the emoticon message can be quickly sent by inputting an operation, such as Tap, based on the emoticon select control. Optionally, a preset emoticon control switching operation may be used to control more emoticon select controls to be displayed in the preset emoticon input region. For example, an operation of swiping to left is input for the preset emoticon input region, and then more emoticon select controls may be presented from right to left.

According to the message display method provided in this embodiment of the present disclosure, a plurality of users who are making a call may interact with each other by sending various types of messages during the process of viewing shared content, and different types of messages may be displayed in different modes. A display position of a text message is associated with a user identifier of a user who sends the message, such that a sense of companionship between the users can be enhanced. A display position of an emoticon message is in a different region from the display position of the text message, and the emoticon message may be displayed randomly in an entire display region of the preset media content, such that the interestingness is enhanced. Corresponding display conditions are respectively set for the display of the text message and of the emoticon message, which takes the timeliness of the messages and the prevention of excessively covering the shared content into consideration, effectively improving the user experience during call sharing.

FIG. 7 is a block diagram of a structure of a message display apparatus according to an embodiment of the present disclosure. The apparatus may be implemented by software and/or hardware, may generally be integrated into an electronic device, and may implement message display by performing a message display method. As shown in FIG. 7, the apparatus includes the following modules:
a content sharing interface display module 701 configured to display a content sharing interface during content sharing between at least two users, where the content sharing interface is used to present preset media content shared between the at least two users, and user identifiers of a first size of the at least two users are displayed in a preset region of the content sharing interface;
a message receiving module 702 configured to receive a first message sent by a first user; and
a message display module 703 configured to display the first message at a first position in the content sharing interface that is associated with a first user identifier, where the first user identifier is a user identifier corresponding to the first user, and the first position is included in a first region.

According to the message display apparatus provided in this embodiment of the present disclosure, a plurality of users who are sharing content may interact with each other by sending messages during the process of viewing shared content, such that the forms of interaction between the users in a sharing scenario when voice interaction is not suitable are enriched, and the convenience for interaction is ensured. In addition, a display position of a message is associated with a user identifier of a user who sends the message, which can enhance a sense of companionship between the users, facilitate enlivening an interactive atmosphere and improve an interaction effect.

Optionally, the message display module 703 is configured to display the first message at the first position in the content sharing interface that is associated with the first user identifier, when a first preset display condition is satisfied.

Optionally, the first preset display condition being satisfied includes the following: a number of messages currently displayed in the first region does not reach a first preset number threshold.

Optionally, the apparatus further includes: a display stopping module configured to, after the first message is displayed at the first position in the content sharing interface that is associated with the first user identifier, stop the display of the first message when a display duration of the first message reaches a first preset duration.

Optionally, the apparatus further includes:
a first duration determination module configured to: when the first message is displayed and the first message is a message that is displayed earliest among messages currently displayed in the first region, and a second message that is sent by a second user and that is to be displayed in the first region is received, determine, if a number of messages currently displayed in the first region has reached a first preset number threshold, whether a display duration of the first message reaches a second preset duration, where the second preset duration is less than a first preset duration; and
a first display module configured to stop the display of the first message if the display duration of the first message has reached the second preset duration, and display the second message at a second position in the first region that is associated with a second user identifier, where the second user identifier is a user identifier corresponding to the second user.

Optionally, the apparatus further includes:
a second display module configured to: when the first message is displayed and the first message is a message that is displayed earliest among messages currently displayed in the first region, and a second message that is sent by a second user and that is to be displayed in the first region is received, stop the display of the first message if a number of messages currently displayed in the first region has reached a first preset number threshold, and display the second message at a second position in the first region that is associated with a second user identifier, where the second user identifier is a user identifier corresponding to the second user.

Optionally, for a display state of the user identifier, a user identifier of a second size is further included, and the second size is different from the first size in magnitude. The apparatus further includes: an identifier switching module configured to perform switching between the display of the user identifier of the first size and the display of the user identifier of the second size when a preset switching operation is received.

Optionally, the message display module 703 is configured to display the first message at the first position in the content sharing interface that is associated with the first user identifier, when a first preset display condition is satisfied, where the first preset display condition is determined based on the display state of the user identifier.

Optionally, the first preset display condition being satisfied includes the following: switching between the display of the user identifier of the first size and the display of the user identifier of the second size is not currently performed.

Optionally, the first preset display condition being satisfied includes the following: a number of messages currently displayed in the first region does not reach a first preset number threshold, where the first preset number threshold is determined based on the display state of the user identifier, and a first preset number threshold in a display state of a large-sized user identifier is greater than a first preset number in a display state of a small-sized user identifier.

Optionally, a presentation mode of a currently displayed message is determined based on the display state of the user identifier.

Optionally, a presentation mode of a currently displayed message includes at least one of a size of the first region, a position of the first region, a relative position between the first region and the user identifier, a font of message content, a font size of the message content, and a layout of the message content.

Optionally, the user identifier of the first size includes a real-time video image of a corresponding user, and/or the user identifier of the second size includes an avatar of a corresponding user.

Optionally, the message display module 703 is further configured to: before the first message is displayed, if it is determined that it is currently a display state of the user identifier of the second size, stop the display of a user identifier corresponding to a user, other than the first user, in the at least two users when the first message is displayed.

Optionally, the apparatus further includes: an input box display module configured to receive a preset trigger operation that acts on a third message displayed in the first region, and display a message input box.

Optionally, the third message is sent by a third user. The apparatus further includes: an associated information display module configured to display associated information of the third user in the message input box while the message input box is displayed.

Optionally, a message displayed in the first region is a text message, where the text message includes a character string.

Optionally, the apparatus further includes:
a receiving module configured to receive a fourth message sent by a fourth user; and
a display module configured to display the fourth message in a second region of the content sharing interface, where the fourth message is a picture message, the picture message includes a preset picture resource, and the second region is different from the first region.

Optionally, the display module is configured to: associatively present the preset picture resource in the fourth message and an avatar of the fourth user in the second region of the content sharing interface.

Optionally, the display module is configured to: display the fourth message in the second region of the content sharing interface when a second preset display condition is satisfied. The first preset display condition being satisfied includes the following: a number of messages currently displayed in the second region does not reach a second preset number threshold, and/or a frequency at which the fourth user sends the picture message does not reach a preset frequency threshold.

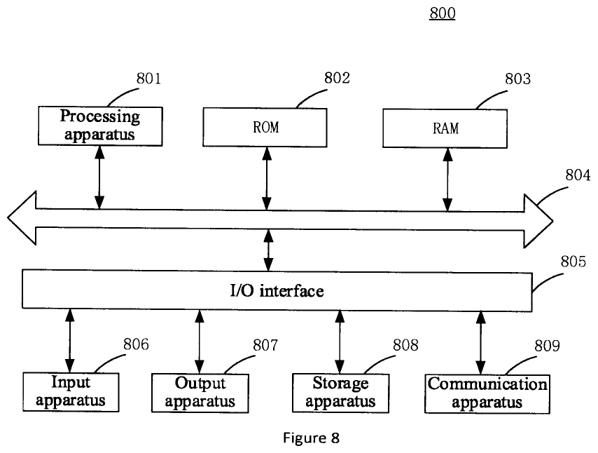

Reference is made to FIG. 8 below, which is a schematic diagram of a structure of an electronic device 800 suitable for implementing an embodiment of the present disclosure. The electronic device in this embodiment of the present disclosure may include mobile terminals such as a mobile phone, a notebook computer, a digital broadcast receiver, a personal digital assistant (PDA), a portable Android device (PAD), a portable multimedia player (PMP), and a vehicle-mounted terminal (for example, a vehicle navigation terminal), and fixed terminals such as a digital television (TV) and a desktop computer. The electronic device shown in FIG. 8 is merely an example, and shall not impose any limitation on the function and scope of use of the embodiments of the present disclosure.

As shown in FIG. 8, the electronic device 800 may include a processing apparatus (for example, a central processing unit or a graphics processing unit) 801. The processing apparatus 801 may perform a variety of appropriate actions and processing in accordance with a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

The following apparatuses may be connected to the I/O interface 805: an input apparatus 806 including, for example, a touchscreen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although FIG. 8 shows the electronic device 800 having various apparatuses, it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 809 and installed, installed from the storage apparatus 808, or installed from the ROM 802. When the computer program is executed by the processing apparatus 801, the above-mentioned functions defined in the method of the embodiment of the present disclosure are performed.

The above computer-readable medium described in the present disclosure may be a computer-readable signal medium, or a computer-readable storage medium, or any combination thereof. The computer-readable storage medium may be, for example, electric, magnetic, optical, electromagnetic, infrared, or semiconductor systems, apparatuses, or devices, or any combination thereof. The computer-readable storage medium may include: an electrical connection having one or more wires, a portable computer magnetic disk, a hard disk, a RAM, a ROM, an erasable programmable read-only memory (EPROM), a flash memory, an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including: electric wires, optical cables, radio frequency (RF), etc., or any suitable combination thereof.

The above computer-readable medium may be contained in the above electronic device. Alternatively, the computer-readable medium may exist independently, without being assembled into the electronic device. The storage medium may be a non-transitory storage medium.

The above computer-readable medium carries one or more programs that, when executed by the electronic device, cause the electronic device to: display a content sharing interface during content sharing between at least two users, where the content sharing interface is used to present preset media content shared between the at least two users, and user identifiers of a first size of the at least two users are displayed in the content sharing interface; receive a first message sent by a first user; and display the first message at a first position in the content sharing interface that is associated with a first user identifier, where the first user identifier is a user identifier corresponding to the first user, and the first position is included in a first region.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. When a remote computer is involved, the remote computer may be connected to a user computer through any type of network, including a local area network (LAN) or a wide area network (WAN), or may be connected to an external computer (for example, connected by using an Internet service provider through the Internet).

The flowcharts and the block diagrams in the accompanying drawings illustrate possible system architectures, functions, and operations of the system, the method, and the computer program product according to various embodiments of the present disclosure. In this regard, each block in the flowcharts or the block diagrams may represent a part of a module, a program segment, or code. The part of the module, the program segment, or the code includes one or more executable instructions for implementing a specified logical function. In some alternative implementations, functions marked in the blocks may occur in a sequence different from that marked in the accompanying drawings. For example, two blocks shown in succession may actually be executed substantially in parallel, or may sometimes be executed in a reverse order, depending on a function involved. Each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. The name of a module does not constitute a limitation on the module itself in some cases. For example, the message receiving module may also be described as “a module for receiving a first message sent by a first user”.

The functions described herein above may be performed at least partially by one or more hardware logic components. For example, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatus, or devices, or any suitable combination thereof. The machine-readable storage medium may include an electrical connection based on one or more wires, a portable computer disk, a hard disk, a RAM, a ROM, an EPROM, a flash memory, an optic fiber, a portable CD-ROM, an optical storage device, a magnetic storage device, or any suitable combination thereof.

According to one or more embodiments of the present disclosure, there is provided a message display method. The method includes:
displaying a content sharing interface during content sharing between at least two users, where the content sharing interface is used to present preset media content shared between the at least two users, and user identifiers of a first size of the at least two users are displayed in the content sharing interface;
receiving a first message sent by a first user; and
displaying the first message at a first position in the content sharing interface that is associated with a first user identifier, where the first user identifier is a user identifier corresponding to the first user, and the first position is included in a first region.

The displaying the first message at a first position in the content sharing interface that is associated with a first user identifier includes: displaying the first message at the first position in the content sharing interface that is associated with the first user identifier, when a first preset display condition is satisfied.

The first preset display condition being satisfied includes the following: a number of messages currently displayed in the first region does not reach a first preset number threshold.

After the displaying the first message at a first position in the content sharing interface that is associated with a first user identifier, the method further includes: stopping the display of the first message after a display duration of the first message reaches a first preset duration.

The method further includes: when the first message is displayed and the first message is a message that is displayed earliest among messages currently displayed in the first region, and a second message that is sent by a second user and that is to be displayed in the first region is received, determining, if a number of messages currently displayed in the first region has reached a first preset number threshold, whether a display duration of the first message reaches a second preset duration, where the second preset duration is less than a first preset duration; and stopping the display of the first message if the display duration of the first message has reached the second preset duration, and displaying the second message at a second position in the first region that is associated with a second user identifier, where the second user identifier is a user identifier corresponding to the second user.

The method further includes: when the first message is displayed and the first message is a message that is displayed earliest among messages currently displayed in the first region, and a second message that is sent by a second user and that is to be displayed in the first region is received, stopping the display of the first message if a number of messages currently displayed in the first region has reached a first preset number threshold, and displaying the second message at a second position in the first region that is associated with a second user identifier, where the second user identifier is a user identifier corresponding to the second user.

A display state of the user identifier further includes a user identifier of a second size, and the second size is less than the first size. The method further includes: performing switching between the display of the user identifier of the first size and the display of the user identifier of the second size when a preset switching operation is received.

The displaying the first message at a first position in the content sharing interface that is associated with a first user identifier includes: displaying the first message at the first position in the content sharing interface that is associated with the first user identifier, when a first preset display condition is satisfied, where the first preset display condition is determined based on the display state of the user identifier.

The first preset display condition being satisfied includes the following: switching between the display of the user identifier of the first size and the display of the user identifier of the second size is not currently performed.

The first preset display condition being satisfied includes the following: a number of messages currently displayed in the first region does not reach a first preset number threshold, where the first preset number threshold is determined based on the display state of the user identifier, and a first preset number threshold in a display state of the user identifier of the first size is greater than a first preset number in a display state of the user identifier of the second size.

A presentation mode of a currently displayed message is determined based on the display state of the user identifier.

A presentation mode of a currently displayed message includes at least one of a size of the first region, a position of the first region, a relative position between the first region and the user identifier, a presentation style of message content, and a layout of the message content.

The user identifier of the first size includes a real-time video image of a corresponding user, and/or the user identifier of the second size includes an avatar of a corresponding user.

Before the first message is displayed, if it is determined that it is currently a display state of the user identifier of the second size, the display of a user identifier corresponding to a user, other than the first user, in the at least two users is stopped when the first message is displayed.

The method further includes: receiving a preset trigger operation that acts on a third message displayed in the first region, and displaying a message input box.

The third message is sent by a third user. While the message input box is displayed, the method further includes: displaying associated information of the third user in the message input box.

A message displayed in the first region is a text message, where the text message includes a character string.

The method further includes: receiving a fourth message sent by a fourth user; and displaying the fourth message in a second region of the content sharing interface, where the fourth message is a picture message, the picture message includes a preset picture resource, and the second region is different from the first region.

The displaying the fourth message in a second region of the content sharing interface includes: associatively presenting the preset picture resource in the fourth message and an avatar of the fourth user in the second region of the content sharing interface.

The displaying the fourth message in a second region of the content sharing interface includes:
displaying the fourth message in the second region of the content sharing interface when a second preset display condition is satisfied. The first preset display condition being satisfied includes the following: a number of messages currently displayed in the second region does not reach a second preset number threshold, and/or a frequency at which the fourth user sends the picture message does not reach a preset frequency threshold.

According to one or more embodiments of the present disclosure, there is provided a message display apparatus. The apparatus includes:
a content sharing interface display module configured to display a content sharing interface during content sharing between at least two users, where the content sharing interface is used to present preset media content shared between the at least two users, and user identifiers of a first size of the at least two users are displayed in the content sharing interface;
a message receiving module configured to receive a first message sent by a first user; and
a message display module configured to display the first message at a first position in the content sharing interface that is associated with a first user identifier, where the first user identifier is a user identifier corresponding to the first user, and the first position is included in a first region.

Furthermore, although the various operations are depicted in a specific order, it should not be construed as requiring these operations to be performed in the specific order shown or in a sequential order. Under certain circumstances, multitasking and parallel processing may be advantageous. Similarly, although a plurality of implementation details are included in the foregoing discussions, these details should not be construed as limiting the scope of the present disclosure. Some features that are described in the context of separate embodiments may alternatively be implemented in combination in a single embodiment. In contrast, a plurality of features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A message display method, comprising:
displaying a content sharing interface during content sharing between at least two users, wherein the content sharing interface is used to present preset media content shared between the at least two users, and user identifiers of the at least two users are displayed in the content sharing interface;
receiving a first message sent by a first user; and
displaying the first message in the content sharing interface that is associated with a first user identifier, wherein the first user identifier is a user identifier corresponding to the first user.

2. The method according to claim 1, wherein the displaying the first message in the content sharing interface that is associated with a first user identifier comprises:
displaying the first message at a first position in the content sharing interface that is associated with the first user identifier in response to a first preset display condition is satisfied, wherein the first position is comprised in a first region.

3. The method according to claim 2, wherein the first preset display condition being satisfied comprises the following:
a number of messages currently displayed in the first region does not reach a first preset number threshold.

4. The method according to claim 3, wherein after the displaying the first message at a first position in the content sharing interface that is associated with a first user identifier, the method further comprises:
stopping the display of the first message after a display duration of the first message reaches a first preset duration.

5. The method according to claim 1, wherein the method further comprises:
in response to the first message is displayed and the first message is a message that is displayed earliest among messages currently displayed in a first region, and a second message that is sent by a second user and that is to be displayed in the first region is received, determining, in response to a number of messages currently displayed in the first region having reached a first preset number threshold, whether a display duration of the first message reaches a second preset duration, wherein the second preset duration is less than a first preset duration; and
in response to the display duration of the first message has reached the second preset duration, stopping the display of the first message, and displaying the second message at a second position in the first region that is associated with a second user identifier, wherein the second user identifier is a user identifier corresponding to the second user.

6. The method according to claim 1, wherein the method further comprises:
in response to the first message is displayed and the first message is a message that is displayed earliest among messages currently displayed in a first region, and a second message that is sent by a second user and that is to be displayed in the first region is received, stopping the display of the first message in response to a number of messages currently displayed in the first region having reached a first preset number threshold, and displaying the second message at a second position in the first region that is associated with a second user identifier, wherein the second user identifier is a user identifier corresponding to the second user.

7. The method according to claim 1, wherein a display state of the user identifier comprises a first size and a second size, the second size is less than the first size, and the method further comprises:
performing switching between the display of the user identifier of the first size and the display of the user identifier of the second size in response to a preset switching operation is received.

8. The method according to claim 7, wherein the displaying the first message at a first position in the content sharing interface that is associated with a first user identifier comprises:
displaying the first message at the first position in the content sharing interface that is associated with the first user identifier in response to a first preset display condition is satisfied, wherein the first preset display condition is determined based on the display state of the user identifier.

9. The method according to claim 8, wherein the first preset display condition being satisfied comprises the following:
switching between the display of the user identifier of the first size and the display of the user identifier of the second size is not currently performed.

10. The method according to claim 8, wherein the first preset display condition being satisfied comprises the following:
a number of messages currently displayed in a first region does not reach a first preset number threshold, wherein the first preset number threshold is determined based on the display state of the user identifier, and a first preset number threshold in a display state of the user identifier of the first size is greater than a first preset number in a display state of the user identifier of the second size.

11. The method according to claim 7,
wherein a presentation mode of a currently displayed message is determined based on the display state of the user identifier, and/or
wherein a presentation mode of a currently displayed message comprises at least one of the following: a size of a first region, a position of the first region, a relative position between the first region and the user identifier, a presentation style of message content, and a layout of the message content.

12. (canceled)

13. The method according to claim 7, wherein the user identifier of the first size comprises a real-time video image of a user corresponding to the user identifier of the first size, or the user identifier of the second size comprises an avatar of a user corresponding to the user identifier of the second size, or the user identifier of the first size comprises a real-time video image of a user corresponding to the user identifier of the first size and the user identifier of the second size comprises an avatar of a user corresponding to the user identifier of the second size.

14. The method according to claim 7, wherein before the first message is displayed, in response to determining that it is currently a display state of the user identifier of the second size, stopping the display of a user identifier corresponding to a user, other than the first user, in the at least two users in response to the first message is displayed.

15. The method according to claim 1, wherein the method further comprises:
receiving a preset trigger operation that acts on a third message displayed in a first region, and displaying a message input box.

16. The method according to claim 15, wherein the third message is sent by a third user, and while the message input box is displayed, the method further comprises:
displaying associated information of the third user in the message input box.

17. The method according to claim 1, wherein a message displayed in a first region is a text message, wherein the text message comprises a character string.

18. The method according to claim 17, wherein the method further comprises:
receiving a fourth message sent by a fourth user; and
displaying the fourth message in a second region of the content sharing interface, wherein the fourth message is a picture message, the picture message comprises a preset picture resource, and the second region is different from the first region.

19. The method according to claim 18,
wherein the displaying the fourth message in a second region of the content sharing interface comprises:
associatively presenting the preset picture resource in the fourth message and an avatar of the fourth user in the second region of the content sharing interface, and/or
wherein the displaying the fourth message in a second region of the content sharing interface comprises:
displaying the fourth message in the second region of the content sharing interface in response to a second preset display condition is satisfied,
wherein the second preset display condition being satisfied comprises at least one of the following: a number of messages currently displayed in the second region does not reach a second preset number threshold, or a frequency at which the fourth user sends the picture message does not reach a preset frequency threshold.

20-22. (canceled)

23. An electronic device, comprising a memory, a processor, and a computer program stored on the memory and executable on the processor, wherein the computer program, when executed by the processor, causes the processor to:
display a content sharing interface during content sharing between at least two users, wherein the content sharing interface is used to present preset media content shared between the at least two users, and user identifiers of the at least two users are displayed in the content sharing interface;
receive a first message sent by a first user; and
display the first message in the content sharing interface that is associated with a first user identifier, wherein the first user identifier is a user identifier corresponding to the first user.

24. A non-transitory computer-readable storage medium storing a computer program, wherein wherein the computer program, when executed by a processor, causes the processor to:
display a content sharing interface during content sharing between at least two users, wherein the content sharing interface is used to present preset media content shared between the at least two users, and user identifiers of the at least two users are displayed in the content sharing interface;
receive a first message sent by a first user; and
display the first message in the content sharing interface that is associated with a first user identifier, wherein the first user identifier is a user identifier corresponding to the first user.
